(19) United States
(12) Patent Application Publication
(10) Pub. No.: US 2008/0291134 A1
(43) Pub. Date: Nov. 27, 2008

(54) Plasma display

(76) Inventors: Tae-Hyun Kim, Suwon-si (KR); Seung-Rock Choi, Suwon-si (KR)

Correspondence Address: ROBERT E. BUSHNELL, 1522 K STREET NW, SUITE 300, WASHINGTON, DC, 20005-1202, US

(21) Appl. No.: 12/153,771

(22) Filed: May 23, 2008

(30) Foreign Application Priority Data
May 23, 2007 (KR) 10-2007-0050363

(51) Int. Cl. G09G 3/28

(52) U.S. Cl. 345/67; 345/68

(57) ABSTRACT

The present invention relates to a plasma display and a driving method thereof. In the plasma display, a plasma display panel (PDP) has different electrode arrangement configurations of discharge cells neighboring in a column direction and a closed barrier rib configuration. When the PDP has an alignment error in first and second electrodes, different rising slopes or falling slopes of a sustain pulse are applied to the first and second electrodes during a sustain period of a subfield.

### CLAIM OF PRIORITY

This application makes reference to, incorporates the same herein, and claims all benefits accruing under 35 U.S.C. §119 from an application earlier filed in the Korean Intellectual Property Office on the 23 May 2007 and there duly assigned Serial No. 10-2007-0050363.

### BACKGROUND OF THE INVENTION

1. Field of the Invention

The present invention relates to a plasma display.

2. Description of the Related Art

A plasma display is a display device employing a plasma display panel (PDP) configured to display characters and/or images using plasma generated by means of gas discharge, and the plasma display has higher luminance and luminous efficiency and a wider viewing angle compared to other displays. Accordingly, the plasma display is being highlighted as a device for replacing conventional cathode ray tubes (CRTs) for large-screen displays of more than 40 inches.

Generally, a plasma display panel (PDP) of the plasma display includes a plurality of address electrodes (hereinafter referred to as “A electrodes”) extending in a column direction, and a plurality of sustain and scan electrodes (hereinafter respectively referred to as “X electrodes” and “Y electrodes”) in pairs extending in a row direction. The A electrodes are formed to cross the X and Y electrodes. A configuration in which the X electrodes and Y electrodes are sequentially arranged in a column direction is referred to as an “XYXY arrangement configuration”. Here, a space formed by the A, X, and Y electrodes forms a discharge cell.

A resolution of the plasma display is determined according to the number of discharge cells formed in the PDP, and the PDP is now being developed to increase the resolution (i.e., to realize high-definition).

To achieve the high-definition, it is required to reduce the size of each of the discharge cells formed in the PDP to increase the number of discharge cells. However, the total capacitance increases as the number of discharge cells increases, and the discharge efficiency decreases as the size of discharge cells decreases.

Accordingly, configuration for the arrangement of X and Y electrodes, which can be achieved by modifying the XYXY configuration, has been developed, and used to solve the problem of the increase of capacitance in the high-definition display. In these new configurations, a phosphor coating area increases by using a closed type barrier rib configuration of the discharge cell to improve the discharge efficiency. In the closed type barrier rib configuration, neighboring discharge cells are separated by barrier ribs. In further detail, one discharge cell is surrounded by the barrier rib.

However, in the PDP having the closed type barrier rib configuration (hereinafter, referred to as a “closed barrier rib configuration”) and different electrode arrangement configurations between the neighboring discharge cells (i.e., arrangement configurations of the X and Y electrodes), image streaking can be generated between electrodes of even and odd line numbers when an alignment error for the X and Y electrodes occurs. The term “image streaking” refers to a phenomenon of luminance difference between neighboring discharge cells while the same driving waveform is applied to the neighboring discharge cells.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display for improving image quality and for removing image streaking effect in a plasma display panel (PDP), which has a image streaking between electrodes of even and odd line numbers that can be caused by an alignment error, and a driving method thereof.

An exemplary embodiment of the present invention provides a plasma display including a plasma display panel (PDP) and a driver. The PDP includes a plurality of first electrodes extending in a first direction, a plurality of second electrodes extending in the first direction, a plurality of third electrodes extending in a second direction crossing the first direction, and discharge cells formed at crossing regions of the first, second, and third electrodes. The PDP has different electrode arrangement configurations between two discharge cells neighboring in the second direction.

In the plasma display, the driver applies a first sustain pulse to the plurality of first electrodes and applies a second sustain pulse to the plurality of second electrodes. The first sustain pulse alternately has a first voltage and a second voltage, and a voltage of the first sustain pulse changes from the first voltage to the second voltage with a first slope during a first period. The second sustain pulse alternately has a third voltage and a fourth voltage, and a voltage of the second sustain pulse changes from the third voltage to the fourth voltage with a second slope during a second period. The first slope is different from the second slope, or the first period is different from the second period.

Another embodiment of the present invention provides a driving method of a plasma display including a plasma display panel (PDP) and a driver. The PDP includes a plurality of first electrodes extending in a first direction, a plurality of second electrodes extending in the first direction, a plurality of third electrodes extending in a second direction crossing the first direction, and discharge cells formed at crossing regions of the first, second, and third electrodes. The PDP has an alignment error for the first and second electrodes

In the plasma display, the driver applies a first sustain pulse to the plurality of first electrodes and applies a second sustain pulse to the plurality of second electrodes. The first sustain pulse alternately has a first voltage and a second voltage, and a voltage of the first sustain pulse changes from the first voltage to the second voltage with a first slope during a first period. The second sustain pulse alternately has a third voltage and a fourth voltage, and a voltage of the second sustain pulse changes from the third voltage to the fourth voltage with a second slope during a second period. The first slope is different from the second slope, or the first period is different from the second period.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a diagram of a plasma display presented according to an exemplary embodiment of the present invention;

FIG. 2 shows a diagram of a configuration of electrodes of a plasma display panel (PDP) constructed as an exemplary embodiment of the present invention;

FIG. 3 shows a diagram of a configuration of electrodes of the PDP constructed as another embodiment of the present invention;

FIG. 4 shows a diagram of a configuration of a closed barrier rib constructed in an exemplary embodiment of the present invention;

FIG. 5 shows a diagram of a configuration of the closed barrier rib constructed in another exemplary embodiment of the present invention;

FIG. 6 shows a diagram of a configuration of the closed barrier rib constructed as yet another exemplary embodiment of the present invention;

FIG. 7 shows a diagram representing areas of the sustain and scan electrodes of the PDP having no alignment error;

FIG. 8 shows a diagram representing areas of the sustain and scan electrodes in the PDP having an alignment error;

FIGS. 9A and 9B show an electrode arrangement configuration diagram of two neighboring discharge cells in the PDP having the alignment error;

FIG. 10 shows a driving waveform diagram of the scan and sustain electrodes during the sustain period of the driving of the plasma display of an exemplary embodiment of the present invention; and

FIG. 11 shows a driving waveform diagram of the scan and sustain electrodes during the sustain period of the driving of the plasma display of another exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

A plasma display according to an exemplary embodiment of the present invention and a driving method thereof will be described with reference to the figures.

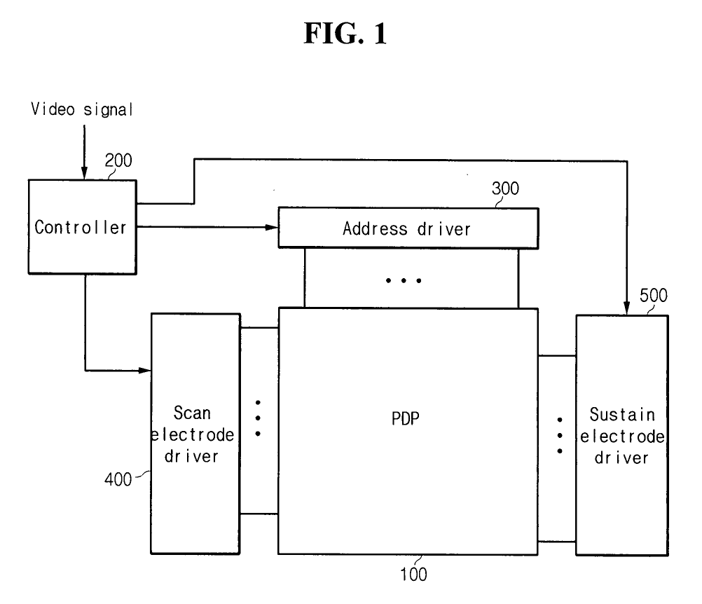

FIG. 1 shows a diagram of the plasma display presented according to an exemplary embodiment of the present invention. As shown in FIG. 1, the plasma display of the exemplary embodiment of the present invention includes plasma display panel (PDP) 100, controller 200, address driver 300, scan electrode driver 400, and sustain electrode driver 500.

PDP 100 includes a plurality of A electrodes (address electrodes) extending in a column direction, and a plurality of X electrodes (sustain electrodes) and Y electrodes (scan electrodes) extending in a row direction. Each of the X electrodes is formed respectively corresponding to one of the Y electrodes, and end portions of the X electrodes may be connected together through a common electrode (not shown). The A electrodes cross the X and Y electrodes. A space formed at a crossing region of each of the A electrodes and each pair of the X and Y electrodes forms a discharge cell or a discharge space. A barrier rib is provided between neighboring discharge cells, and the neighboring discharge cells have different electrode arrangement configurations. Respective electrode arrangement configurations of the PDP and a configuration of the discharge cell will be described later in the specification.

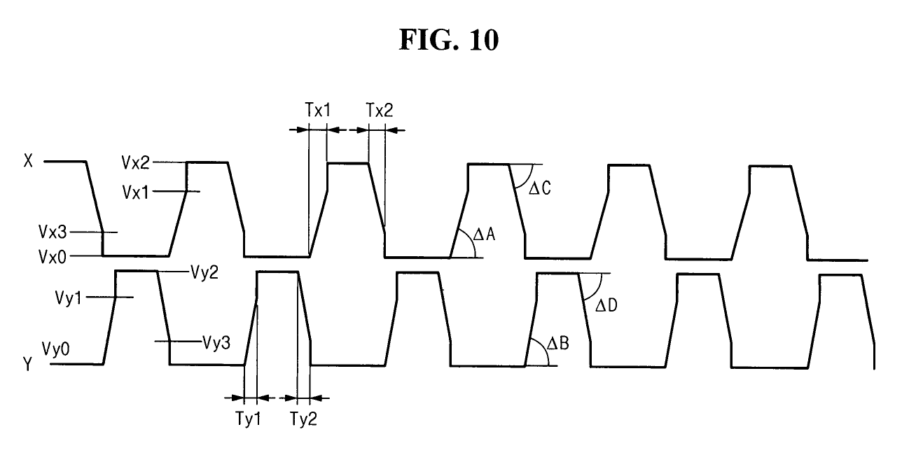

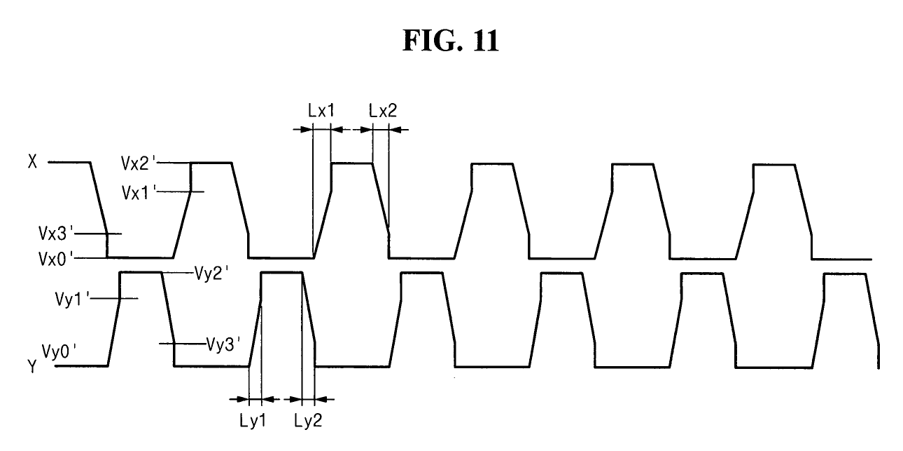

Controller 200 divides one frame of a driving waveform into a plurality of subfields, each of which has a weight to achieve grayscales. Accordingly, controller 200 receives external video signals, and outputs an address driving control signal, a sustain electrode driving control signal, and a scan electrode driving control signal. In this case, controller 200 outputs the sustain and scan electrode driving control signals for controlling an X electrode driving waveform and a Y electrode driving waveform, respectively. If there is no alignment error in the arrangement of the X and Y electrodes of PDP 100, controller 200 outputs sustain and scan electrode driving control signals that are applied to establish a normal driving waveforms. However, if there is an error in the arrangement of the X and Y electrodes of PDP 100, controller 200 outputs sustain and scan electrode driving signals that are designed to generate compensated driving waveforms (as shown in FIG. 10 and FIG. 11), which can be made by changing the established normal driving waveform.

After receiving the address driving control signal from controller 200, address driver 300 applies a display data signal to the respective A electrodes for selecting discharge cells to be displayed.

Scan electrode driver 400 generates a driving waveform according to the scan electrode driving control signal received from controller 200, and applies the driving waveform to the Y electrodes. In this case, when receiving the scan electrode driving control signal for generating the compensated driving waveforms from controller 200, scan electrode driver 400 outputs the Y electrode driving waveform as shown in FIG. 10.

Sustain electrode driver 500 generates a driving waveform according to the sustain electrode driving control signal received from controller 200, and applies the driving waveform to the X electrode. In this case, when receiving the sustain electrode driving control signal for generating the compensated driving waveforms from controller 200, sustain electrode driver 500 outputs the X electrode driving signal as shown in FIG. 10 or FIG. 11.

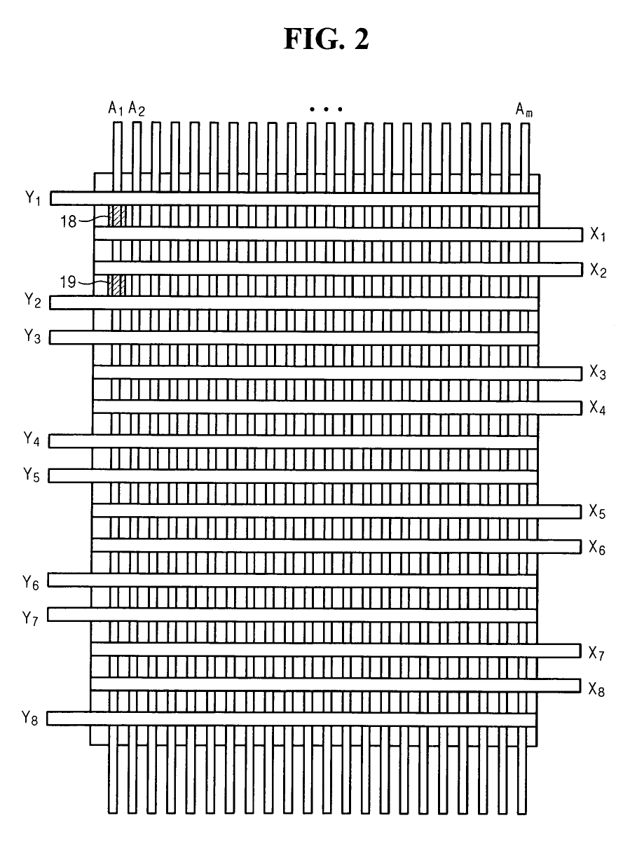

The PDP of the plasma display constructed as an exemplary embodiment of the present invention will be described with reference to FIG. 2 to FIG. 6.

As described above, the PDP according to an exemplary embodiment of the present invention has different electrode arrangement configurations between two discharge cells which neighbors in the column direction, and a barrier rib of the discharge cell has a closed barrier rib configuration.

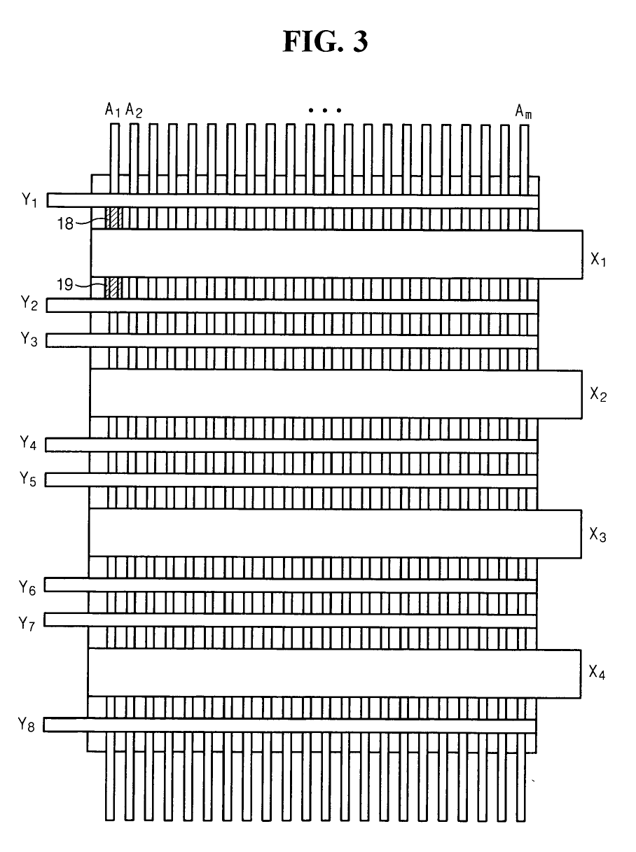

Firstly, the different electrode arrangement configurations will be described with reference to FIG. 2 and FIG. 3.

FIG. 2 shows a diagram of a configuration of electrodes of the PDP constructed as an exemplary embodiment of the present invention. The PDP shown in FIG. 2 includes a plurality of A electrodes A1, A2, . . . , and Am extended in a column direction, and a plurality of X electrode X1, X2, . . . and a plurality of Y electrodes Y1, Y2, . . . , both of which are extended in a row direction, which is substantially perpendicular to the column direction. For easy description, eight X electrodes X1 to X8 and eight Y electrodes Y1 to Y8 are shown in FIG. 2. A pair of X electrodes and a pair of Y electrodes is alternately arranged as proceeding along the column direction. The arrangement configuration of the X and Y electrodes shown in FIG. 2 is referred to as an “XXYY arrangement configuration.”

In the XXYY arrangement configuration, one discharge cell 18 is formed at a crossing region of a Y electrode, an X electrode, and an A electrode. In FIG. 2, two neighboring discharge cells 18 and 19 in the column direction are denoted by their reference numerals to compare configurations of the neighboring discharge cells. A Y electrode (Y1) is provided on the upper side of upper discharge cell 18, and an X electrode (X1) is provided on the lower side of upper discharge cell 18. Further, another X electrode (X2) is provided on the upper side of lower discharge cell 19, and another Y electrode (Y2) is provided on the lower side of lower discharge cell 19. That is, the two neighboring discharge cells 18 and 19 have the different electrode arrangement configurations.

Another example of the neighboring discharge cell configurations will be described with reference to FIG. 3. FIG. 3 shows a diagram of a configuration of electrodes of a PDP constructed as another exemplary embodiment of the present invention. The PDP shown in FIG. 3 includes a plurality of address electrodes A1, A2, . . . , and Am in a column direction, and a plurality of X electrode X, X2, . . . and a plurality of Y electrodes Y1, Y2, . . . , both of which are extended in a row direction, which is substantially perpendicular to the column direction. One X electrode and a pair of Y electrodes are alternately arranged when viewed along the column direction. The arrangement configuration of the X and Y electrodes shown in FIG. 3 is referred to as an “XYY arrangement configuration.”

In this electrode arrangement configuration, the discharge cell 18 or 19 is formed at the crossing region of the Y electrode, the X electrode, and the A electrode. In FIG. 3, two neighboring discharge cells 18 and 19 are denoted by their reference numerals to compare configurations of the neighboring discharge cells. A Y electrode (Y1) is provided on the upper side of upper discharge cell 18, and an X electrode (X1) is provided on the lower side of upper discharge cell 18. Further, the X electrode (X1) is provided on the upper side of lower discharge cell 19, and another Y electrode (Y2) is provided on the lower side of lower discharge cell 19. That is, the two neighboring cells 18 and 19 which are adjacent in the column direction share one X electrode (X1) and have the different electrode arrangement configurations.

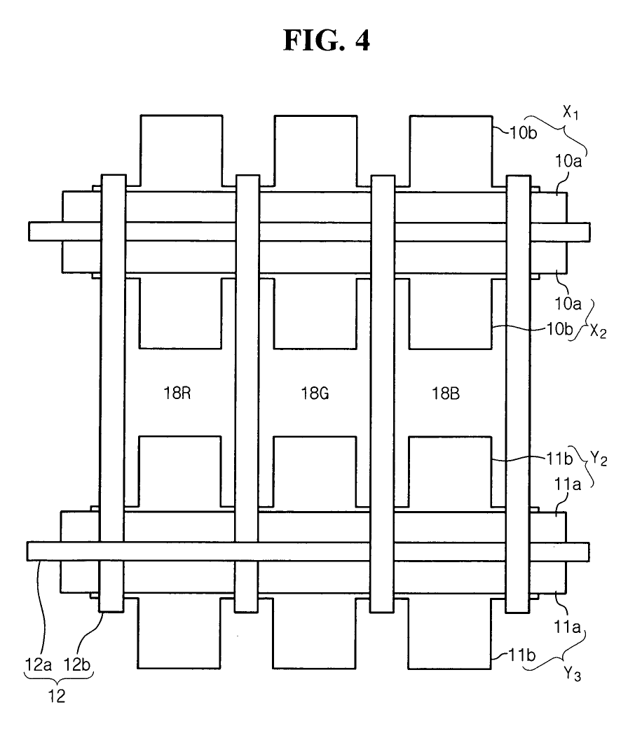

An example of the closed barrier rib will be described with reference to FIG. 4 to FIG. 6. FIG. 4 shows a diagram of a configuration of a closed barrier rib constructed in an exemplary embodiment of the present invention, which has an XXYY arrangement configuration. Herein, an XYY arrangement configuration also can be used instead of the XXYY arrangement configuration.

As shown in FIG. 4, barrier rib 12 includes first barrier rib member 12a extending in a row direction, and second barrier rib member 12b extending in a column direction. In this case, first barrier rib member 12a is formed to separate a discharge cell from neighboring discharge cells in a column direction, and second barrier rib member 12b is formed to separate the discharge cell from the neighboring discharge cells in a row direction.

Each of discharge cells 18R, 18G, and 18B is separated from other discharge cells by the first barrier rib member 12a and the second barrier rib member 12b. Phosphor layers for emitting visible light for each color may be respectively formed in the discharge cells separated by the barrier ribs. The discharge cell can be referred to as red discharge cell 18R, green discharge cell 18G, or blue discharge cells 18B according to a color produced from the phosphor layer. A combined discharge gas, for example a gas including neon and xenon may be provided in the discharge cells 18R, 18G, and 18B.

According to the XXYY arrangement configuration, the pairs of X electrodes X1 and X2 or the pairs of Y electrodes Y2 and Y3 are arranged on one first barrier rib member 12a. Each of the arranged X and Y electrodes is formed by a combination of a bus electrode 10a or 11a and a transparent electrode 10b or 11b. In this case, bus electrodes 10a and 11a of the X and Y electrodes extends in the row direction, and transparent electrodes 10b of the X electrodes and transparent electrodes 11b of the Y electrodes protrude to face each other.

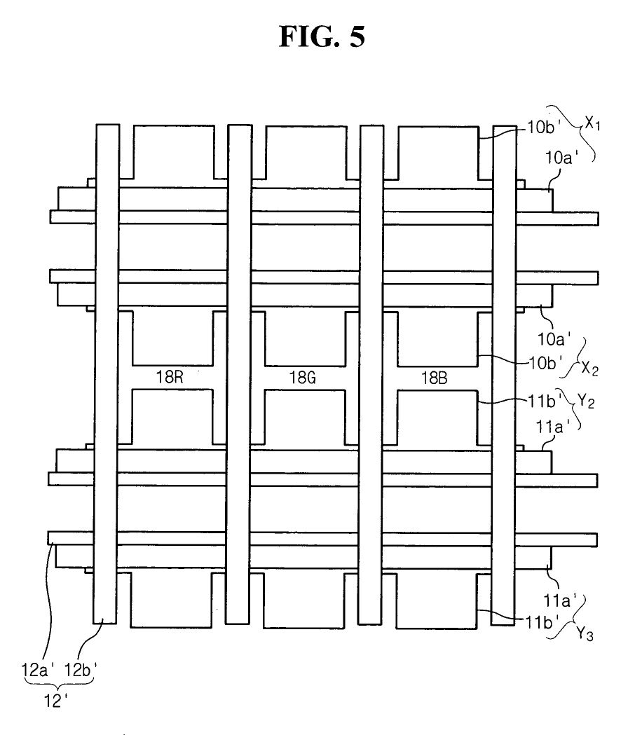

Another example of the closed barrier rib will now be described with reference to FIG. 5. FIG. 5 shows a diagram of a configuration of a closed barrier rib constructed in another exemplary embodiment of the present invention.

As shown in FIG. 5, barrier rib 12′ includes first barrier rib member 12a′ extending in a row direction, and second barrier rib member 12b′ extending in column direction. In this case, pairs of first barrier rib members 12a′ are separated so that first barrier rib members 12a′ may not be shared by neighboring discharge cells in the column direction.

Accordingly, two first barrier rib members 12a′ separate a discharge cell from neighboring discharge cells in the column direction. One second barrier rib member 12b′ separates a discharge cell from the neighboring discharge cells in a row direction. Therefore, discharge cells 18R, 18G, and 18B are separated from other discharge cells by the first barrier rib members 12a′ and the second barrier rib members 12b′.

As described, the phosphor layers for each color may be respectively formed in the discharge cells separated by the barrier ribs. The discharge cells may be referred to as red discharge cells 18R, green discharge cells 18G, and blue discharge cells 18B according to the color produced from the phosphor layer. The combined discharge gas, for example a gas including neon and xenon may be provided in discharge cells 18R, 18G, and 18B.

According to the XXYY arrangement configuration, two neighboring X electrodes X1 and X2 and two neighboring Y electrodes Y2 and Y3 are respectively arranged on pairs of first barrier rib members 12a′. Each of the arranged X and Y electrodes is formed by a combination of a bus electrode 10a′ or 11a′ and a transparent electrode 10b′ or 11b′. In this case, the bus electrodes 10a′ and 11a′ of the X and Y electrodes extends in the row direction, and the transparent electrodes 10b′ of the X electrodes and transparent electrodes 11b′ of the Y electrodes protrude to face each other.

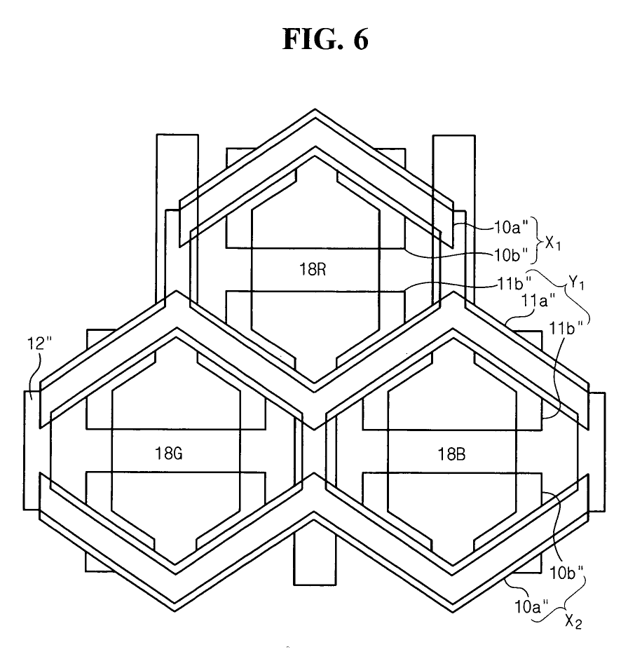

A third example of the closed barrier rib will be described with reference to FIG. 6. FIG. 6 shows a configuration of the closed barrier rib constructed as yet another exemplary embodiment of the present invention.

The closed barrier rib configuration shown in FIG. 6 includes a hexagonal discharge cell, shape of which is different from those shown in FIG. 4 and FIG. 5. The barrier rib 12″ defining the hexagonal discharge cell includes six barrier rib members extending in respective directions. That is, the barrier rib 12″ includes two first barrier rib members extending in a forward slash direction, two second barrier rib members extending in a backslash direction and being connected to the respective first barrier rib members, and two third barrier rib members extending in the column directions and connecting the respective first barrier rib members and the respective second barrier rib members. The barrier rib 12″ is formed to separate a discharge cell from neighboring discharge cells by the six barrier rib members extending in the respective directions.

The respective discharge cells 18R, 18G, and 18B are separated from neighboring discharge cells by the six barrier rib members that are connected in a closed loop.

As described, the phosphor layers for each color are respectively formed in the discharge cells separated by the barrier ribs. The discharge cells are referred to as red discharge cells 18R, green discharge cells 18G, and blue discharge cells 18B according to the color produced from the phosphor layer. The combined discharge gas including neon and xenon is provided in discharge cells 18R, 18G, and 18B.

Each of the X and Y electrodes is formed in a combination of a bus electrode 10a″ or 11a″ and a transparent electrode 10b″ or 11b″. In this case, bus electrodes 10a″ and 11a″ of the X and Y electrodes extends in the row direction along with the first and second barrier rib members, and transparent electrodes 10b″ of the X electrode and transparent electrode 11b″ of the Y electrodes protrude to face each other.

Compared to a stripe barrier rib configuration, a plasma discharge, in the discharge cell of the closed barrier rib configuration, is generated in a limited area separated by the barrier rib, and an area of the phosphor layer is wider.

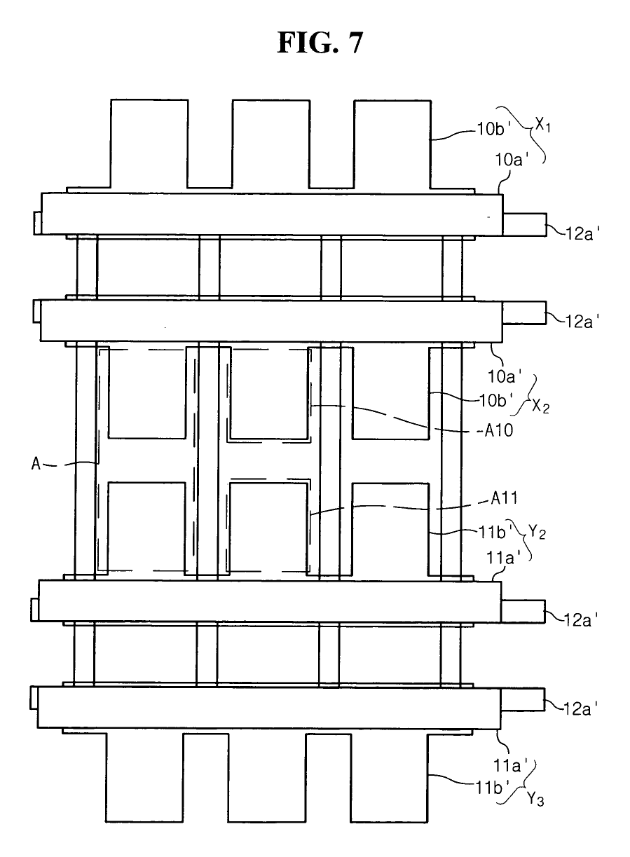

An area of the sustain and scan electrodes (i.e., a discharge area) in the discharge cell of the PDP without an alignment error will be described with reference to FIG. 7. FIG. 7 shows a diagram representing the area of the sustain and scan electrodes of the PDP without an alignment error. The closed barrier rib configuration shown in FIG. 5 is exemplified in FIG. 7.

As shown in FIG. 7, there is no alignment error when the bus electrodes of the X and Y electrodes are formed to correspond to the first barrier rib member extending in a row direction. When there is no alignment error, space A surrounded by the barrier rib member 12a′ in a row direction and the barrier rib member 12b′ in a column direction is used as a discharge space. Herein, a first area of each electrode 10b′ or 11b′ is defined as an area inside discharge space A that is occupied by transparent electrode 10b′ of the X electrode (area A10) or the transparent electrode 11b′ of the Y electrode (area A11). First area A10 of transparent electrode 100b′ is an area inside discharge space A that is occupied by transparent electrode 10b′, and can be different from actual area of transparent electrode 10b′ depending on alignment and design. First area A11 of transparent electrode 11b′ is an area inside discharge space A that is occupied by transparent electrode 11b′, and can be different from actual area of transparent electrode 11b′. A second area of each transparent electrode is defined as an area of actual transparent electrodes 10b′ or 11b′ that are protruded from X electrode or Y electrode, respectively. As shown in FIG. 7, if there is no alignment error, the actual areas of transparent electrodes 10b′ and 11b′ are substantially the same as areas A10 and A11, respectively. In other words, the first area of each transparent electrode and the second area of the each transparent electrode are the same.

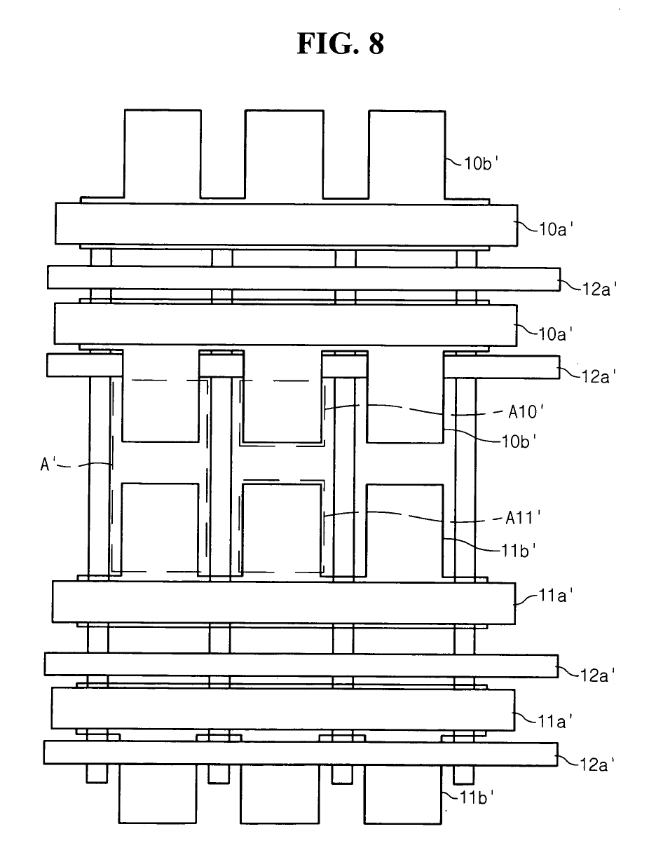

The area of the sustain and scan electrodes in the discharge cell of the PDP having the alignment error will be described with reference to FIG. 8. FIG. 8 shows a diagram representing the area of the sustain and scan electrodes in the PDP having an alignment error.

As shown in FIG. 8, an alignment error is generated when the bus electrodes 10a′ and 11a′ of the X and Y electrodes are formed to deviate from the first barrier rib 12a′ extending in a row direction. When the alignment error is generated, a length of the discharge space of each discharge cell along the column direction is reduced by the amount of the alignment error (i.e., a distance between first barrier rib member 12a′ extending in the row direction and the X electrode (or the Y electrode)). Accordingly, an area of space A′ is reduced, and becomes smaller than the area of discharge space A surrounded by the barrier rib that is shown in FIG. 7. Space A′ is used as a discharge space in the respective discharge cells. In this case, area A10′, which is an area inside discharge space A′ that is occupied by transparent electrode 10b′, is smaller than the actual area of transparent electrode 10b′. However, area A11′, which is an area inside discharge space A′ that is occupied by transparent electrode 11b′, is substantially the same as the actual area of transparent electrode 11b′. That is, when there is an alignment error, one of the areas A10′ and A11′ can be smaller than the actual area of the respective electrode, and the other can be the same as the actual area of the respective electrode.

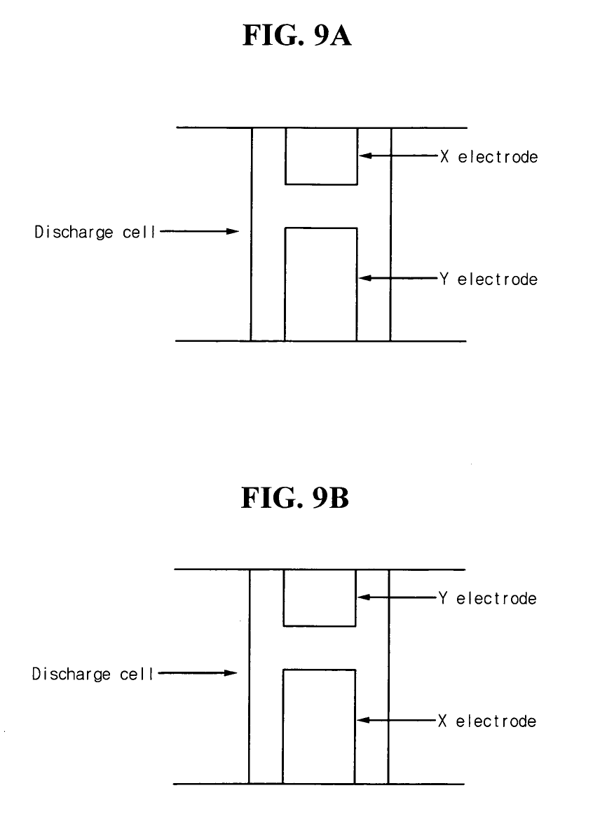

Accordingly, when the alignment error is generated, as shown in FIG. 8 and FIG. 9A, the first area of transparent electrode of the X electrode in a first discharge cell is smaller than the second area of the first discharge cell, and the first area of transparent electrode of the Y electrode in the first discharge cell is substantially the same as the second area in the first discharge cell. In addition, in a second discharge cell neighboring the first discharge cell in a column direction, the first area of transparent electrode of the X electrode in the second discharge cell is substantially the same as the second area in the second discharge cell as shown in FIG. 9B, and the first area of the transparent electrode of the Y electrode in the second discharge cell is smaller than the second area of the second discharge cell.

A sustain pulse which alternately has a high level voltage and a low level voltage is applied to the X electrode in the sustain period. In addition, a sustain pulse which has a different phase from the sustain pulse applied to the X electrode is applied to the Y electrode in the sustain period.

However, the sustain pulses actually applied to the X and Y electrodes are different since there is an impedance difference between driving circuits of scan and sustain electrode drivers 400 and 500. The sustain pulse generated by the driving circuit of sustain electrode driver 500 is directly applied to the X electrode, but the sustain pulse generated by the driving circuit of scan electrode driver 400 is applied to the Y electrode via further circuits, for example scan integrated circuits (ICs) formed on a printed circuit board (PCB). Accordingly, the driving circuit of scan electrode driver 400 has parasitic impedance by the scan ICs and parasitic impedance caused by the PCB pattern. That is, the driving circuit of scan electrode driver 400 has higher impedance than the driving circuit of sustain electrode driver 500.

The impedance of the respective driving circuits is applied to the sustain pulse, and therefore the luminance of the discharge cell according to the X electrode sustain pulse and the luminance of the discharge cell according to the Y electrode sustain pulse may be different. For example, the luminance of the discharge cell according to the X electrode sustain pulse may be higher due to the lower impedance, and the luminance of the discharge cell according to the Y electrode sustain pulse may be lower due to the higher impedance.

Generally, the light emission of the discharge cell is directly proportional to the area of the transparent electrode. That is, the luminance greatly varies according to a variation of the area of the transparent electrode in the electrode having the higher luminance for each sustain pulse.

Accordingly, in the respective neighboring discharge cells having the closed rib configuration and the different electrode arrangement configurations, discharge characteristics between the X and Y electrodes vary according to the size of the first area and the discharge space. That is, different discharge characteristics can be observed between the even and odd lines. Therefore, the image streaking may be generated between the even and odd lines.

However, the luminance according to the X electrode sustain pulse is not always high when the impedance of the X electrode is lower than that of the Y electrode because the sustain pulse waveform is differently distorted according to switching timing for generating the driving waveform in the transistor and impedance matching, and the luminance according to the sustain pulse may vary. Accordingly, even when the impedance of the Y electrode is higher than that of the X electrode, the luminance of the X electrode may be brighter or darker than that of the Y electrode.

A method for solving an image streaking problem will now be described with reference to FIGS. 9A, 9B, 10, and 11.

FIGS. 9A and 9B show an electrode arrangement configuration diagram of two neighboring discharge cells in the PDP having an alignment error. In further detail, FIG. 9A shows a discharge cell configuration of the odd line and FIG. 9B shows a discharge cell configuration of the even line. Hereinafter, the discharge cell of the odd line shown in FIG. 9A will be referred to as an A type of discharge cell, and the discharge cell of the even line shown in FIG. 9B will be referred to as a B type of discharge cell.

The first area of transparent electrode the X electrode is smaller than that of the Y electrode in the A type of discharge cell. The first area of transparent electrode of the X electrode is greater than that of the transparent electrode of the Y electrode in the B type of discharge cell.

A driving method of exemplary embodiments of the present invention will be described with reference to FIG. 10 and FIG. 11.

Firstly, for better understanding and ease of description, discharge characteristics (i.e., the luminescence characteristics) in the A and B type of discharge cells in a normal state in which a rising slope and a falling slope of a sustain pulse applied to the X electrode during the sustain period are respectively the same as a rising slope and a falling slope of a sustain pulse applied to the Y electrode during the sustain period will be described.

The following description is for the case that the luminance for an unit area of the X electrode by each sustain pulse is greater than the luminance for the unit area of the Y electrode by each sustain pulse. In the A type of discharge cell, a first luminance is formed when the sustain pulse is applied to the X electrode, and a second luminance is formed when the sustain pulse is applied to the Y electrode. In this case, even when the luminance for the unit area of the X electrode is greater than that of the Y electrode, since the first area of the Y electrode is greater than that of the X electrode, the second luminance is greater than the first luminance.

In the B type of discharge cell, a fourth luminance is formed when the sustain pulse is applied to the X electrode and a third luminance is formed when the sustain pulse is applied to the Y electrode. In this case, since the luminance for the unit area of the X electrode is greater than that of the Y electrode and the first area of the X electrode is greater than that of the Y electrode, the fourth luminance is greater than the third luminance.

The fourth luminance formed by applying the sustain pulse to the X electrode in the B type of discharge cell, in which the first area of the X electrode is the same as the second area of the X electrode, is higher than the first to third luminances. The third luminance formed by applying the sustain pulse to the Y electrode in the B type of discharge cell, in which the first area of the Y electrode is smaller than the second area of the Y electrode, is lower than the first, second, and fourth luminances. That is, the fourth luminance is greater than the second luminance, the second luminance is greater than the first luminance, and the first luminance is greater than the third luminance.

In addition, since the luminance for the unit area of the X electrode by each sustain pulse is greater than the luminance for the unit area of the Y electrode by each sustain pulse, the luminance of the A type of discharge cell is lower than the B type of discharge cells. As a result, the image streaking is generated between the odd and even lines (or between the A type and B type of discharge cells).

A driving method according to an exemplary embodiment of the present invention to solve the image streaking will be described with reference to FIG. 10.

FIG. 10 shows a driving waveform diagram of the scan and sustain electrodes during the sustain period of the driving method of the plasma display according to an exemplary embodiment of the present invention. In FIG. 10, the description is for the case that the luminance for the unit area of the X electrode by each sustain pulse is greater than the luminance for the unit area of the Y electrode by each sustain pulse.

When the alignment error is generated between the X and Y electrodes in the PDP, controller 200 outputs the sustain and scan electrode driving control signals for compensating the image streaking. Accordingly, scan electrode driver 400 and sustain electrode driver 500 output the sustain pulses shown in FIG. 10 during the sustain period.

As shown in FIG. 10, the sustain pulse alternately having low and high level voltages is applied to the X and Y electrodes during the sustain period. The sustain pulse applied to X electrode and the sustain pulse applied to Y electrode are out of phase as shown in FIGS. 10 and 11. In other words, the phase of the sustain pulse applied to the X electrode and the sustain pulse applied to the Y electrode has a phase difference of about 180 degrees. Herein, the Y and X electrodes can be referred to as first and second electrodes. The address electrode, then, can be referred to as a third electrode. The sustain pulse applied to the X and Y electrodes has a rising period (Tx1 or Ty1) for gradually increasing from a reference voltage (Vx0 or Vy0) to a first voltage (Vx1 or Vy1) with a rising slope (ΔA or ΔB) and subsequently increasing to a second voltage (Vx2 or Vy2) that is higher than the first voltage, and it has a falling period (Tx2 or Ty2) for gradually decreasing from the second voltage to a third voltage (Vx3 or Vy3) with a falling slope (ΔC or ΔD) and subsequently decreasing to the reference voltage.

However, the rising slope ΔA of the sustain pulse applied to the X electrode is different from the rising slope ΔB of the sustain pulse applied to the Y electrode, and the falling slope ΔC of the sustain pulse applied to the X electrode is different from the falling slope ΔD of the sustain pulse applied to the Y electrode.

In further detail, the rising slope ΔA is less (gentler) than a rising slope of a normal sustain pulse, and the falling slope ΔC is less (gentler) than the falling slope of the normal sustain pulse. In addition, the rising slope ΔB is greater (steeper) than the rising slope of the normal sustain pulse, and the falling slope ΔD is greater (steeper) than the falling slope of the normal sustain pulse. Here, the above normal sustain pulse is a sustain pulse applied to the X and Y electrodes of the PDP having no alignment error. The rising slope of the normal sustain pulse can be referred to as a reference rising slope, and the falling slope of the normal sustain pulse can be referred to as a reference falling slope. Therefore, the rising slope ΔA is less than the reference rising slope, and the falling slope ΔC is less than the reference falling slope. The rising slope ΔB is greater than the reference rising slope, and the falling slope ΔD is greater than the reference falling slope.

In addition, variations of the rising and falling slopes may be in proportion to the alignment error values. For example, the variation of the rising and falling slopes is set low for the normal sustain pulse when the alignment error of the PDP is low, and it is set high when the alignment error of the PDP is great.

Accordingly, the rising slope ΔA is less than the rising slope ΔB, and the falling slope ΔC is less than the falling slope ΔD.

The luminescence characteristics formed when the X and Y electrode sustain pulses are applied to the A and B type of discharge cells shown in FIGS. 9A and 9B will be described.

When the X electrode sustain pulse having the reduced rising slope ΔA and falling slope ΔC is applied to the A type of discharge cell, an amount of light emission according to the reduced rising and falling slopes is reduced, and a fifth luminance that is lower than the first luminance is formed.

When the Y electrode sustain pulse having the increased rising slope ΔB and falling slope ΔD is applied to the A type of discharge cell, an amount of light emission according to the increased rising and falling slopes is increased, and a sixth luminance that is higher than the second luminance is formed.

When the X electrode sustain pulse having the reduced rising slope ΔA and falling slope ΔC is applied to the B type of discharge cell, an amount of light emission according to the reduced rising and falling slopes is reduced, and a seventh luminance that is lower than the fourth luminance is formed.

When the Y electrode sustain pulse having the increased rising slope ΔB and falling slope ΔD is applied to the B type of discharge cell, an amount of light emission according to the increased rising and falling slopes is increased, and an eighth luminance that is higher than the third luminance is formed.

In addition, the amount of light emission may vary by the rising slope, may vary by the falling slope, or may vary by the rising and falling slopes. Therefore, when the amount of light emission varies by the rising slope, differing from the driving waveforms shown in FIG. 10, only the rising slopes ΔA and ΔB may be reduced to be lower or increased to be higher than the rising slope of the normal sustain pulse. In the same manner, when the amount of light emission varies by the falling slope, differing from the driving waveforms shown in FIG. 10, only the falling slopes ΔC and ΔD may be reduced to be lower or increased to be higher than the falling slope of the normal sustain pulse.

In the above descriptions, it has been described that the fourth luminance is greater than the second luminance, the second luminance is greater than the first luminance, and the first luminance is greater than the third luminance.

In this case, by the driving waveform shown in FIG. 10, the seventh luminance decreased from the fourth luminance is formed in the B type of discharge cell, and the sixth luminance increased from the second luminance is formed in the A type of discharge cell.

In addition, by the driving waveform shown in FIG. 10, the eighth luminance increased from the third luminance is formed in the B type of discharge cell, and the fifth luminance decreased from the first luminance is formed in the A type of discharge cell.

In the respective discharge cells, while a sum of the fifth and sixth luminances is formed in the A type of discharge cell, a sum of the seventh and eighth luminances is formed in the B type of discharge cell. In this case, a difference between the second luminance and the sixth luminance is greater than a difference between the first luminance and the fifth luminance since the area of the Y electrode is greater than the area of the X electrode in the A type of discharge cell. Accordingly, the luminance of the A type of discharge cell is increased. However, a difference between the fourth luminance and the seventh luminance is greater than a difference between the third luminance and the eighth luminance since the area of the X electrode is greater than the area of the Y electrode in the B type of discharge cell. Accordingly, the luminance of the B type of discharge cell is decreased.

Therefore, at the same time, the luminance formed in the A discharge cell is almost the same as that of the B type of discharge cell, and the problem of the image streaking between the even and odd lines is solved.

In addition, differing from the above exemplary embodiment of the present invention, the luminance for the unit area of the Y electrode by each sustain pulse may be greater than the luminance for the unit area of the X electrode by each sustain pulse. In this case, the sustain pulses shown in FIG. 10 are switched and applied to the electrodes, according to another exemplary embodiment of the present invention. That is, according to another exemplary embodiment of the present invention, the rising and falling slopes of the sustain pulse applied to the X electrode are increased, and the rising and falling slopes of the sustain pulse applied to the Y electrode are reduced.

A driving method for solving the image streaking according to yet another exemplary embodiment of the present invention will be described with reference to FIG. 11.

FIG. 11 shows a waveform diagram of the scan and sustain electrodes during the sustain period of the driving method of the plasma display according to yet another exemplary embodiment of the present invention. In FIG. 11, the luminance for the unit area of the X electrode by each sustain pulse is greater than the luminance for the unit area of the Y electrode by each sustain pulse.

When the alignment error is generated between the X and Y electrodes in the PDP, controller 200 outputs the sustain and scan electrode driving control signals for compensating the image streaking. Accordingly, scan electrode driver 400 and sustain electrode driver 500 output the sustain pulses shown in FIG. 11 during the sustain period.

As shown in FIG. 11, the sustain pulse alternately having the low and high level voltages is applied to the X and Y electrodes during the sustain period. The sustain pulse applied to the X and Y electrodes has a rising period (Lx1 or Ly1) for gradually increasing from a reference voltage (Vx0′ or Vy0′) to a first voltage (Vx1′ or Vy1′) and subsequently increasing to a second voltage (Vx2′ or Vy2′) that is higher than the first voltage, and it has a falling period (Lx2 or Ly2) for gradually decreasing from the second voltage to a third voltage (Vx3′ or Vy3′) and subsequently decreasing to the reference voltage.

However, a rising period Lx1 of the sustain pulse applied to the X electrode is different from a rising period Ly1 of the sustain pulse applied to the Y electrode, and a falling period Lx2 of the sustain pulse applied to the X electrode is different from a falling period Ly2 of the sustain pulse applied to the Y electrode.

In further detail, the rising period Lx1 is longer than the rising period of the normal sustain pulse, and the falling period Lx2 is longer than the falling period of the normal sustain pulse. In addition, the rising period Ly1 is shorter than the rising period of the normal sustain pulse, and the falling period Ly2 is shorter than the falling period of the normal sustain pulse. Here, the above normal sustain pulse is the sustain pulse applied to the X and Y electrodes of the PDP having no alignment error.

The variations of the high level period and the high level duration period for the normal sustain pulse may be in proportion to the alignment error values. For example, the variation of the rising and falling periods is set low for the normal sustain pulse when the alignment error of the PDP is low, and the variation of the rising and falling periods is set high for the normal sustain pulse when the alignment error of the PDP is great.

Accordingly, the rising period Lx1 is longer than the rising period Ly1, and the falling period Lx2 is longer than the falling period Ly2.

The luminescence characteristics formed when the X and Y electrode sustain pulses are applied to the A and B types of discharge cells shown in FIGS. 9A and 9B will be described.

When the sustain pulse having the increased rising period Lx1 and falling period Lx2 is applied to the A type of discharge cell, an applying time of the second voltage is delayed, and the fifth luminance that is lower than the first luminance is formed.

When the sustain pulse having the reduced rising period Ly1 and falling period Ly2 is applied to the A type of discharge cell, the applying time of the second voltage is advanced, and the sixth luminance that is higher than the second luminance is formed.

When the sustain pulse having the increased rising period Lx1 and falling period Lx2 is applied to the B type of discharge cell, the applying time of the second voltage is delayed, and the seventh luminance that is lower than the fourth luminance is formed.

When the sustain pulse having the reduced rising period Ly1 and falling period Ly2 is applied to the B type of discharge cell, the applying time of the second voltage is advanced, and the eighth luminance that is higher than the third luminance is formed.

In the above descriptions, it has been described that the fourth luminance is greater than the second luminance, the second luminance is greater than the first luminance, and the first luminance is greater than the third luminance.

In this case, by the sustain pulses shown in FIG. 11, the seventh luminance decreased from the fourth luminance is formed in the B type of discharge cell, and the sixth luminance increased from the second luminance is formed in the A type of discharge cell.

In addition, by the driving waveform shown in FIG. 11, the eighth luminance increased from the third luminance is formed in the B type of discharge cell, and the fifth luminance decreased from the first luminance is formed in the A type of discharge cell.

In the respective discharge cells, while a sum of the fifth and sixth luminances is formed in the A type of discharge cell, a sum of the seventh and eighth luminance is formed in the B type of discharge cell.

Therefore, at the same time, the luminance formed in the discharge cell is almost the same as that of the B type of discharge cell, and the problem of the image streaking between the even and odd lines is solved.

In addition, differing from the above exemplary embodiment of the present invention, the luminance for the unit area of the Y electrode by each sustain pulse may be greater than the luminance for the unit area of the X electrode by each sustain pulse. In this case, the sustain pulses shown in FIG. 11 are switched and applied to the electrodes, according to still another exemplary embodiment of the present invention. That is, according to still another exemplary embodiment of the present invention, the rising and falling periods of the sustain pulse applied to the X electrode are reduced, and the rising and falling periods of the sustain pulse applied to the Y electrode are increased.

According to the exemplary embodiment of the present invention, in the PDP in which the image streaking is generated between the even and odd lines by the alignment error of the X and Y electrodes, since voltage applying periods and voltage duration periods of the sustain pulse of the X and Y electrodes are different from each other, the problem of the image streaking is solved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display comprising:
a plasma display panel (PDP) comprising a plurality of first electrodes extending in a first direction, a plurality of second electrodes extending in the first direction, a plurality of third electrodes extending in a second direction crossing the first direction, and discharge cells formed at crossing regions of the first, second, and third electrodes, the PDP having different electrode arrangement configurations between neighboring two discharge cells in the second direction; and
a driver that applies a first sustain pulse to the plurality of first electrodes and applies a second sustain pulse to the plurality of second electrodes, the first sustain pulse alternately having a first voltage and a second voltage, a voltage of the first sustain pulse changing from the first voltage to the second voltage with a first slope during a first period, the second sustain pulse alternately having a third voltage and a fourth voltage, a voltage of the second sustain pulse changing from the third voltage to the fourth voltage with a second slope during a second period, and the first slope being different from the second slope or the first period being different from the second period.

2. The plasma display of claim 1, wherein the voltage of the first sustain pulse changes from the second voltage to the first voltage with a third slope during a third period, the voltage of the second sustain pulse changes from the fourth voltage to the third voltage with a fourth slope during a fourth period, and the third slope being different from the fourth slope, or the third period being different from the fourth period.

3. The plasma display of claim 1, wherein the first slope is steeper than the second slope.

4. The plasma display of claim 1, wherein if the first slope and the second slope are the same, a unit area of a first electrode to which the first sustain pulse is applied has lower luminance than a unit area of a second electrode to which the second sustain pulse is applied.

5. The plasma display of claim 1, wherein the first period is shorter than the second period.

6. The plasma display of claim 1, wherein if the first period and the second period are the same, a unit area of a first electrode to which the first sustain pulse is applied has lower luminance than a unit area of a second electrode to which the second sustain pulse is applied.

7. The plasma display of claim 1, wherein the first voltage is lower than the second voltage, and the third voltage is lower than the fourth voltage.

8. The plasma display of claim 1, wherein the first voltage is higher than the second voltage, and the third voltage is higher than the fourth voltage.

9. The plasma display of claim 1, wherein the PDP has an alignment error for the first and second electrodes.

10. The plasma display of claims 1, wherein one of the neighboring two discharge cells having a first electrode located at an upper side and a second electrode located at a lower side, and the other of the neighboring two discharge cells having a first electrode located at the lower side and a second electrode located at the upper side such that the PDP has the different electrode arrangement configurations between the neighboring two discharge cells.

11. The plasma display of claims 10, wherein the PDP has a closed barrier rib configuration.

12. The plasma display of claim 1, wherein the first electrodes are scan electrodes, and the second electrodes are sustain electrodes.

13. A plasma display comprising:
a plasma display panel (PDP) comprising a plurality of first electrodes extending in a first direction, a plurality of second electrodes extending in the first direction, a plurality of third electrodes extending in a second direction crossing the first direction, and discharge cells formed at crossing regions of the first, second, and third electrodes, the PDP having an alignment error for the first and second electrodes; and
a driver that applies a first sustain pulse to the plurality of first electrodes and applies a second sustain pulse to the plurality of second electrodes, the first sustain pulse alternately having a first voltage and a second voltage, a voltage of the first sustain pulse changing from the first voltage to the second voltage with a first slope during a first period, the second sustain pulse alternately having a third voltage and a fourth voltage, a voltage of the second sustain pulse changing from the third voltage to the fourth voltage with a second slope during a second period, and the first slope being different from the second slope or the first period being different from the second period.

14. The plasma display of claim 13, wherein the voltage of the first sustain pulse changing from the second voltage to the first voltage with a third slope during a third period, the voltage of the second sustain pulse changing from the fourth voltage to the third voltage with a fourth slope during a fourth period, and the third slope being different from the fourth slope, or the third period being different from the fourth period.

15. The plasma display of claim 13, wherein the first slope is steeper than the second slope.

16. The plasma display of claim 13, wherein if the first slope and the second slope are the same, a unit area of a first electrode to which the first sustain pulse is applied has lower luminance than a unit area of a second electrode to which the second sustain pulse is applied.

17. The plasma display of claim 13, wherein the first period is shorter than the second period.

18. The plasma display of claim 13, wherein if the first period and the second period are the same, a unit area of a first electrode to which the first sustain pulse is applied has lower luminance than a unit area of a second electrode to which the second sustain pulse is applied.

19. The plasma display of claim 13, wherein the first voltage is lower than the second voltage, and the third voltage is lower than the fourth voltage.

20. The plasma display of claim 13, wherein the first voltage is higher than the second voltage, and the third voltage is higher than the fourth voltage.

21. The plasma display of claim 13, wherein the PDP has a closed barrier rib configuration.

22. The plasma display of claim 13, wherein the first electrodes are scan electrodes, and the second electrodes are sustain electrodes.
